(19) United States
(12) Patent Application Publication
(10) Pub. No.: US 2025/0289018 A1
(43) Pub. Date: Sep. 18, 2025

(54) CONVEYING DEVICE WITH FLUSHING DEVICE AND METHOD FOR OPERATING THE CONVEYING DEVICE

(71) Applicant: Wagner International AG, Altstätten (CH)

(72) Inventors: Carsten Ludwig, Friedrichshafen (DE); Markus Neundorf, Salem (DE); Thomas Kluser, Diepoldsau (CH); Amu Harif, Au (CH)

(73) Assignee: Wagner International AG, Altstätten (CH)

(21) Appl. No.: 19/071,952

(22) Filed: Mar. 6, 2025

(30) Foreign Application Priority Data
Mar. 14, 2024 (EP) 24163689.3

(51) Int. Cl. B05B 15/55; B05B 12/14

(52) U.S. Cl. CPC B05B 15/557; B05B 12/149

(57) ABSTRACT

The conveying device according to the invention with flushing means comprises a material conveyor (1) for conveying coating material (31). The material conveyor (1), in turn, which has an inlet valve (7), which comprises a valve inlet (7.1) and a valve outlet (7.9). The material conveyor (1) additionally has a conveyor inlet (1.1) for coating material (31), which is connected or can be connected to the valve inlet (7.1). The conveying device furthermore comprises a flushing agent conveyor (3) for conveying flushing agent (30), which is likewise connected to the valve inlet (7.1).

### TECHNICAL FIELD

The invention relates to a conveying device with flushing means and a method for operating the conveying device.

In order to coat workpieces with coating material, the coating material is transported out of a storage container to a spray applicator by means of a conveying device and is then sprayed onto the workpiece by means of the spray applicator. The coating material can be, for example, varnish, adhesive or an emulsion with zinc dust. When the coating is completed or the coating material is to be changed, the conveying device, the material-guiding lines and the spray applicator should be cleaned or flushed, respectively. For this purpose, the coating material is replaced with a flushing medium. The flushing medium can be, for example, flushing gas (e.g., compressed air or nitrogen), flushing agent (e.g., solvent or water) or a mixture of flushing gas and flushing agent.

### PRIOR ART

A coating agent pump and a cleaning method for the coating agent pump is known from the prior art EP 2 956 242 B1. The coating agent pump comprises a supply line and a pump inlet connected thereto, via which coating agent is supplied to the pump. The pump inlet is connected to the pump chamber via a non-return valve. In the conveying operation, coating material is sucked into the pump chamber via the pump inlet and the non-return valve and is subsequently pushed out of the pump outlet. The pump additionally comprises a blow-out opening, via which compressed air is supplied to the pump. The blow-out opening is likewise connected to the non-return valve. During the cleaning operation, compressed air is blown through the non-return valve and the coating material is blown out of the pump chamber in the direction of the pump outlet thereby. This solution has the disadvantage that the material-guiding components upstream of the coating material pump, such as, for example, the supply line, are not cleaned. The supply line thus has to be cleaned separately.

### DESCRIPTION OF THE INVENTION

It is an object of the invention to specify a conveying device with flushing means, in the case of which, in addition to the conveying device, the upstream, material-guiding components thereof, such as, for example, the supply line, can also be cleaned by means of the flushing means.

A further object of the invention is to specify a method for operating the conveying device, which is particularly time-efficient.

The operating personnel can particularly easily bring the conveying device according to the invention from the conveying mode into the cleaning mode in an advantageous manner.

It is a further advantage that the need for flushing agent for each color change can be reduced significantly. The disposal costs for waste material (mixture of coating material and flushing agent) can also be reduced therewith.

The object is solved by means of a conveying device with flushing means with the features specified in claim 1.

The conveying device according to the invention with flushing means comprises a material conveyor for conveying coating material. The material conveyor, in turn, has an inlet valve, which comprises a valve inlet and a valve outlet. The material conveyor additionally has a conveyor inlet for coating material, which is connected or can be connected to the valve inlet. The conveying device furthermore comprises a flushing agent conveyor for conveying flushing agent, which is likewise connected to the valve inlet.

Advantageous further developments of the invention follow from the features specified in the dependent patent claims.

In the case of one embodiment of the conveying device according to the invention, the inlet valve is formed as non-return valve. It is attained therewith that the fluid can flow unhindered in the one direction and the return flow (thus the flow in the opposite direction) is automatically prevented. This can be attained by means of a return spring in the non-return valve, which ensures that the non-return valve closes automatically. This increases the efficiency of the conveying device and of the application system and the risk of backflow damages is minimized.

In the case of a further embodiment of the conveying device according to the invention, the inlet valve is formed as disk valve, ball valve or needle valve. The use of a disk valve is particularly advantageous because said disk valve can be embodied so that it can be flushed optimally. The disk valve can additionally handle high flow rates. The disk valve furthermore has a simple construction, which is reliable and low-maintenance.

In the case of an additional embodiment of the conveying device according to the invention, the material conveyor is formed as bellows pump, membrane pump, centrifugal pump, gear pump, peristaltic pump, piston pump, piston dosing system or positive displacement pump. Which embodiment of the material conveyor is most suitable depends on the application. The most suitable material conveyor can be selected depending on the application.

In the case of another embodiment of the conveying device according to the invention, the flushing agent conveyor is connected to the valve inlet via a non-return valve. It is ensured in this way that no coating material gets into the flushing agent line.

The non-return valve is advantageously arranged spatially close to the valve inlet. The dead space can be minimized thereby.

In the case of a further development of the conveying device according to the invention, a shut-off device is present, which is connected to the conveyor inlet on the inlet side and to the inlet valve on the outlet side. The shut-off device is thus arranged between the conveyor inlet and the inlet valve. When the shut-off device is closed, the pressure in the flushing medium can be increased even further. Due to the increased flushing medium pressure, the conveying chambers as well as the downstream material lines and components connecting to the conveying chamber can be cleaned even better. Without the shut-off device, most of the flushing medium would be discharged through the supply line.

In the case of another further development of the conveying device according to the invention, a control is present, which is formed and can be operated in such a way that it controls the shut-off device. This provides for a user-friendly use of the conveying means.

In the case of an additional further development, the conveying device according to the invention has a compressed gas source, which can be connected to the valve inlet. The use of compressed gas as flushing medium or as additive in the flushing medium provides for significant savings of flushing agent.

In the case of a further development, the conveying device according to the invention comprises a compressed gas valve, via which compressed gas originating from the compressed gas source can be admixed to the flushing agent. A mixture of flushing agent and gas is thus generated, which is referred to as flushing medium and which attains a very high cleaning effect due to high flow speeds and turbulences.

The flushing with the flushing medium can take place continuously, discontinuously or in a pulsed manner. When the compressed air is admixed to the flushing agent in pulses via a clocked valve and has a higher pressure than the flushing agent, the flushing agent flow is interrupted intermittently.

In the case of the conveying device according to the invention, the flushing agent conveyor is advantageously connected to the inlet valve via a flushing line. The compressed gas source is additionally connected to the flushing line via a non-return valve. Without this non-return valve, it would be possible that flushing agent gets from the flushing line into the compressed gas line.

It is furthermore proposed that the conveying device according to the invention has a further shut-off device, which is connected to a conveying chamber inlet of the conveying chamber on the output side and which is connected to the flushing agent conveyor on the input side. This embodiment can manage without the shut-off means in front of the valve inlet. The flushing of the conveying device can thus also take place without the shut-off means.

In the case of the conveying device according to the invention, a flushing agent control valve can additionally be provided, which is formed and can be operated in such a way that it controls whether the flushing agent flows to the valve inlet or to the conveying chamber inlet. The conveying device as well as the supply line can be flushed in an advantageous manner with this embodiment.

In the case of one formation of the flushing agent control valve, the flushing of the conveying device and of the supply line take place one after the other. The flushing agent control valve can also be formed and operated so that the conveying device and the supply line are flushed simultaneously.

Another embodiment of the conveying device according to the invention comprises a first compressed gas valve, which is connected to the flushing agent line on the output side and which guides a first compressed gas volume flow \dot{V}1 into the flushing agent line in the open state. A second compressed gas valve is additionally present, which is connected to the flushing agent line on the output side and which guides a second compressed gas volume flow \dot{V}2 into the flushing agent line in the open state. The pressure or volume flow of the compressed gas, respectively, which matches the respective process step, can thus be specified. It is advantageous, for example, to empty the supply line with reduced air pressure or throttled volume flow, in order to prevent contaminations at the end on the supply line when discharging the coating material.

In the case of one embodiment of the conveying device according to the invention, a cam control is present, via which the compressed gas valves can be controlled. This provides for process-reliable and optimized processes with good operability.

In order to set the first compressed gas volume flow \dot{V}1, a throttle, for example, can be provided in the compressed gas line, which leads to the flushing line. In order to set the second compressed gas volume flow \dot{V}2, the compressed gas line can be connected directly to the flushing line, thus by bypassing the throttle. At the beginning of the flushing, the volume flow in the sections to be flushed is still low because viscous or even highly viscous material, which is only pushed out gradually, is still present in these sections. Later, when hardly any viscous material is still present in the sections to be flushed, the volume flow is higher. The volume flow can be restricted via the throttle, so that the volume flow in the supply line (intake hose) does not become too high. It can be prevented thereby that the material spurts out of the supply line.

A further embodiment of the conveying device according to the invention comprises a squeeze valve, which is formed and can be operated in such a way that it opens or closes the conveyor inlet. A squeeze valve provides the opportunity for the effective sealing, in that a hose or a pipeline is squeezed together, in order to stop the throughflow. This is particularly advantageous when abrasive or viscous media are to be conveyed. Due to the simple construction and the lack of movable parts, a squeeze valve is low maintenance and offers a reliable performance over longer operating periods.

An application system is additionally proposed, which comprises the above-mentioned conveying device and an applicator, which is connected to the conveying device. This makes it possible to expand the advantages of the flushing method to the supply line to the applicator and the applicator itself.

In the case of the method according to the invention for operating the above-mentioned conveying device, the downstream side of the conveying device is closed for flushing the supply line. This can take place, for example, by means of a valve. Flushing agent is then conveyed into the supply line with the help of the flushing agent conveyor.

In order to flush the first conveying chamber, the downstream side of the conveying device is opened and flushing agent is conveyed into the first conveying chamber with the help of the flushing agent conveyor. The upstream side of the conveying device should be closed thereby, for example via the valve or by means of a shut-off device.

Due to the optimal order of the flushing procedures, a flushing process, which saves time as well as flushing medium, can thus be carried out with a high level of material recovery and high flushing agent effectiveness.

In the case of a further development of the method according to the invention, flushing takes place in a pulse-like manner. Whether flushing takes place in a pulse-like manner or continuously or whether a mixture of compressed gas and flushing agent or only flushing agent is used, depends on the material, which is to be flushed out. In one case, the pulsed method can therefore be more efficient and, in another case, the flushing with a mixture of compressed gas and flushing agent. Due to the fact that the proposed embodiment provides different flushing methods, the most efficient method can always be selected.

In the case of an additional further development of the method according to the invention, compressed gas is guided to the conveyor inlet with a first compressed gas volume flow \dot{V}1 with the help of the first compressed gas valve, when the compressed gas valve is open. When the compressed gas is to be guided into the conveying chamber, a second compressed gas volume flow \dot{V}2 is set with the help of the second compressed gas valve. An unnecessary contamination in response to the escape of the compressed gas from the supply line can thus be prevented.

The above-described actuation of the valves can take place manually, thus by hand, as well as automatically by means of a control. An automatic control of the valves can thus also take place hereby by means of a control. Further components can also be controlled or regulated, respectively, by means of the control. This can be, for example, the pump pressure of the material conveyor. The drain valve for the drain line in the case of the filter and the drain valve for the drain line in the case of the spray applicator can also be controlled by means of the control. If necessary, the application system can also be automated even further. Changing the containers or lifting the intake hose out of the container can thus also be automated. A manual intervention can then also be dispensed with in this regard in the cleaning mode.

### BRIEF DESCRIPTION OF THE DRAWINGS

The invention will be explained further with several exemplary embodiments on the basis of six figures.

FIG. 1 shows a possible embodiment of the lower section of the material conveyor in a three-dimensional view.

FIG. 2 shows the lower section of the material conveyor in the longitudinal section.

FIG. 3 shows the general layout of a first embodiment of an application system with the material conveyor in a block diagram.

FIG. 4 shows the general layout of a second embodiment of the application system with the material conveyor in a block diagram.

FIG. 5 shows the general layout of an embodiment of a cam control for setting the operating mode of the material conveyor.

FIG. 6 shows a control panel, via which the operating modes of the material conveyor can be set.

### WAYS FOR CARRYING OUT THE INVENTION

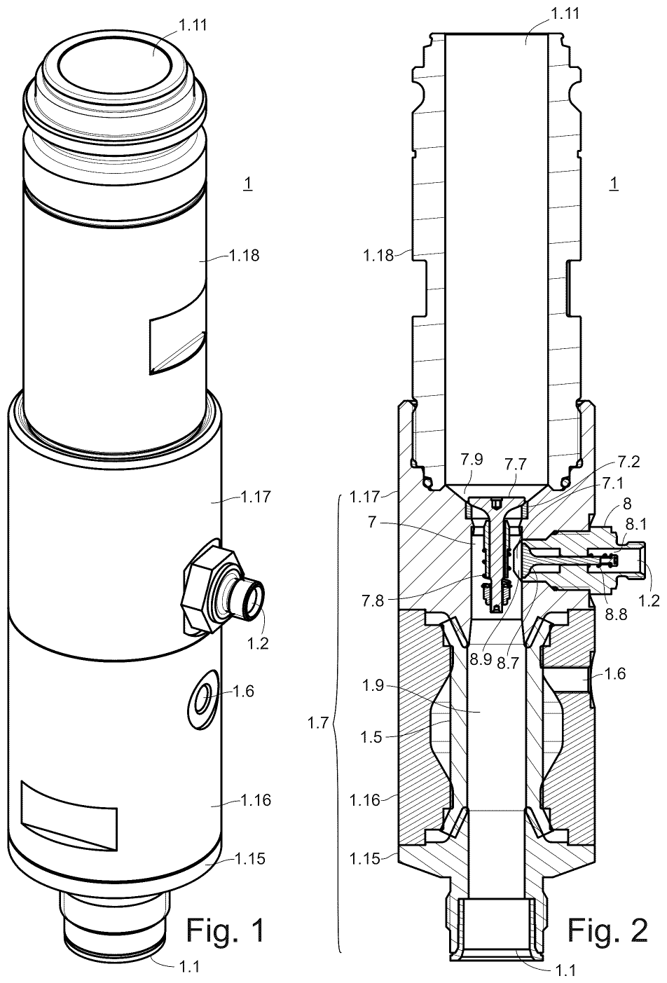

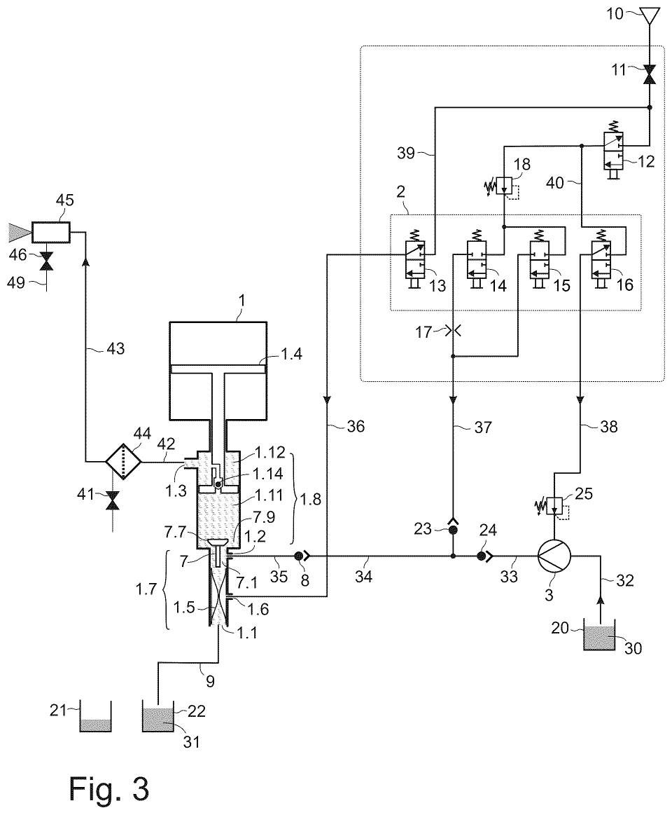

A first possible embodiment of the lower (suction-side) section of a material conveyor 1 is illustrated in FIGS. 1 and 2. This suction-side section of the material conveyor 1 will also be referred to below as intake tract 1.7. The lower part of the compressor stage 1.8 is additionally shown in FIGS. 1 and 2. The coating material conveyor 1 will also be referred to below in short as material conveyor or as conveyor. The material conveyor 1 is preferably part of an application system. The general layout of a first embodiment of the application system is illustrated in FIG. 3. The application system is provided in order to convey coating material 31 out of a storage container 22 via a supply line 9. The storage container 22 is also referred to as material storage container or container for coating material. The material conveyor 1 conveys the coating material 31 or material, in short, out of the storage container 22 and to an applicator 45. From there, it can be applied to a workpiece (not shown in the figures). The applicator 45 can be, for example, a manually actuatable spray gun. An automatically actuatable spray gun is also not ruled out. Several spray guns can also be present, which are connected to the material conveyor 1.

The material conveyor 1 can be formed, for example, as bellows pump, membrane pump, centrifugal pump, gear pump, peristaltic pump, piston pump, piston dosing system or positive displacement pump. The material conveyors shown in FIGS. 1 to 4 are a piston pump, which is driven via an air motor. An electric motor or a hydraulic motor can also be used instead of the air motor, in order to drive the piston 1.4. The electric motor is preferably a servomotor.

The material conveyor 1 comprises an inlet for coating material 1.1 or, in short, material inlet or conveyor inlet, to which a supply line 9 is connected. The supply line 9 can be formed, for example, as pipe or hose and is provided in order to guide coating material 31 out of a storage container 22 to the material conveyor 1. The material inlet 1.1 can be closed with the help of a shut-off device 1.5. The shut-off device 1.5 is preferably formed as squeeze valve. The control of the squeeze valve 1.5 takes place via a control connection 1.6. When compressed air is applied to said control connection, the squeezer expands in the squeeze valve 1.5 and closes the channel 1.9 behind the inlet 1.1. In the pressure-free state, the squeezer is relaxed in the squeeze valve 1.5 and the channel 1.9 is open.

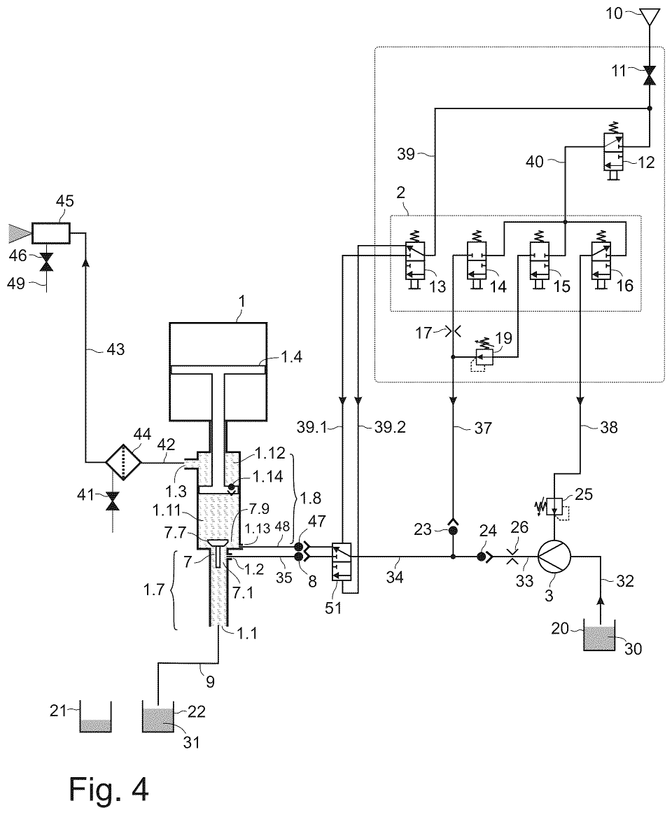

As needed, the shut-off device 1.5 can be actuatable automatically or manually. It can be provided, for example, that the shut-off device 1.5 can be controlled electrically (not shown in the figures) or pneumatically (see FIGS. 3 and 4). The squeeze valve 1.5 is preferably made of a solvent-resistant rubber.

The material conveyor 1 additionally comprises an inlet valve 7, which has a valve inlet 7.1 and a valve outlet 7.9 and a valve disk 7.7 in-between. In the closed state, the valve disk 7.7 sits on the valve seat 7.2. The inlet valve 7 is preferably formed as self-closing valve. For this purpose, the inlet valve 7 can have a return spring 7.8 (see FIG. 2), which ensures that the inlet valve 7.7 is closed in the pressure-free state. It is additionally advantageous when the inlet valve 7 is formed as non-return valve. The inlet valve 7 is preferably installed into the material conveyor 1 so that it closes the conveyor inlet 1.1 when the first conveying chamber 1.11 is pressurized. The inlet valve 7 ensures that the coating material 31 can only flow in one direction, namely in the direction of the spray applicator 45. The inlet valve 7 is preferably formed so that it has a smallest possible dead space. This has the advantage that only little coating material can deposit there, so that the risk of a color spreading in response to a color change is minimized. The inlet valve 7 is preferably formed as disk valve because a disk valve has a particularly small dead space.

The flushing agent inlet 1.2 is preferably also connected to valve inlet 7.1 when the inlet valve 7 is closed.

When the shut-off device (squeeze valve) 1.5 is open, the conveyor inlet 1.1 is connected to the valve inlet 7.1. When the squeeze valve 1.5 is closed, the conveyor inlet 1.1 is not connected to the valve inlet 7.1. The conveyor inlet 1.1 can thus be connected to the valve inlet 7.1 with the help of the squeeze valve 1.5.

The material conveyor 1 additionally has a flushing agent inlet 1.2 for a flushing medium/flushing agent 30. Flushing agent 30 can be taken in from a storage container 20 via a flushing line 32 and can be conveyed to the valve inlet 7.1 via a flushing line 33, a non-return valve 24, a flushing line 34, a non-return valve 8 and a flushing line 35. The flushing medium can be, for example, solvent, water, air or a mixture thereof.

The non-return valve 8 is preferably arranged in the direct vicinity of the valve inlet 7.1 (see FIG. 2). It comprises an inlet 8.1 and an outlet 8.9 and a valve disk 8.7 in-between. The inlet 8.1 of the non-return valve 8 simultaneously forms the flushing agent inlet 1.2 of the material conveyor 1. The non-return valve 8 is preferably formed in a self-closing manner. For this purpose, it can have a return spring 8.8, which ensures that the non-return valve 8 is closed in the non-pressurized state.

The material conveyor 1 additionally comprises a second conveying chamber 1.12, which is connected or can be connected, respectively, to the first conveying chamber 1.1 via a non-return valve 1.14. When the piston 1.4 is moved upwards, the volume of the second conveying chamber 1.12 is decreased and the coating material, which is present therein, is pushed out of the conveyor outlet 1.3 and into the material line 42. A filter 44 can be located between the material line 42 and the material line 43. The coating material can be drained into the remnant container 21 or back into the storage container 22 via a drain valve 41.

As illustrated in FIGS. 3 and 4, a control 2 can be provided in order to control the material conveyor 1 and the flushing agent conveyor 3. The control 2 has a control valve 13, which is connected to a compressed gas source 10 via a line 39 and a shut-off valve 11 on the inlet side. The compressed gas source 10 provides a compressed gas with a defined pressure. The compressed gas can be compressed air or nitrogen, for example. When the control valve 13 is open, the compressed gas gets to the control input 1.6 of the squeeze valve 1.5 via a control line 36.

The control 2 furthermore comprises a compressed gas valve 14, which is connected to the compressed gas source 10 via a flow reducer 18, a compressed gas valve 12 and the shut-off valve 11 on the inlet side. When the compressed gas valve 14 is actuated, compressed gas is fed into the flushing line 34 via a flow reducer 17, a compressed gas line 37 and a non-return valve 23. The flow reducer 17 can be a throttle or a screen, for example. The flow reducer 18 is provided to regulate the rate of flow of the compressed gas.

As safety valve, the compressed gas valve 12 serves the purpose that the system operator does not inadvertently actuate one of the valves 14, 15 or 16 and that flushing medium thereby gets into the material conveyor 1 during the conveying operation. A change-over into the cleaning mode can be made only when the compressed gas valve 12 was actuated. The compressed gas valve 12 is optional.

The control 2 additionally has a compressed gas valve 15, which is connected to the compressed gas source 10 via the flow reducer 18, the compressed gas valve 12 and the shut-off valve 11 on the inlet side. When the compressed gas valve 15 is actuated, compressed gas is fed into the flushing line 34 via the compressed gas line 37 and the non-return valve 23.

When the compressed gas valve 14 is actuated, compressed gas is introduced into the flushing line 34 with a first pressure or compressed gas volume flow \dot{V}1, respectively. When, in contrast, the compressed gas valve 15 is actuated, compressed gas is introduced into the flushing line 34 with a second pressure or compressed gas volume flow \dot{V}2, respectively.

The control 2 furthermore also has a flow valve 16, which is connected to the compressed gas source 10 via the compressed gas valve 12 and the shut-off valve 11 on the inlet side. When the flow valve 16 is actuated, compressed gas is supplied via a compressed gas line 38 and a flow reducer 25 to the flushing agent conveyor 3, in order to drive the latter.

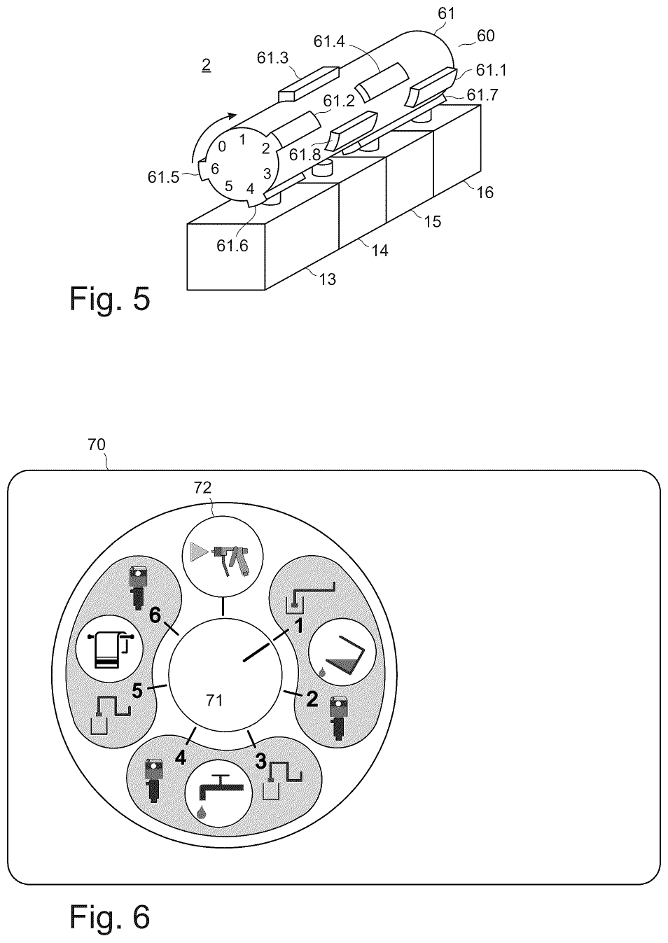

In a preferred embodiment, the control 2 additionally comprises a cam control 60, by means of which the valves 13, 14, 15 and 16 can be actuated. The principle of a possible embodiment of the cam control 60 is illustrated in FIG. 5. The cam control 60 has a cam shaft 61, which can be rotated about its longitudinal axis, with several cams, wherein only the cams 61.1, 61.2, . . . 61.8 can be seen in FIG. 5. In the case of the exemplary embodiment according to FIG. 5, the cam shaft 61 can be rotated in seven different positions 0-6 (see arrow). When the cam shaft 61 is in position 0, the conveying device goes into the conveying mode. In position 0, neither the control valve 13 nor one of the compressed gas valves 14 and 15 or the flow valve 16 are actuated by means of the cams. The valves 13-16 are closed. If the cam shaft 61 is brought into position 4, for example, the compressed gas valve 15 and the flow valve 16 are actuated via the cam 61.7. The valves 15 and 16 are opened thereby. The control valve 13 is additionally actuated (opened) via the cam 61.6. In position 2, the control valve 13 and the compressed gas valve 15 are actuated, i.e., opened, by means of the cams 61.2 and 61.4. In position 1, the compressed gas valve 14 is actuated by means of the cam 61.3.

In the case of the application system according to FIG. 4, the coating material conveyor 1 has a conveying chamber inlet 1.13, which is connected to a flushing agent control valve 51 via a flushing agent line 48 and a non-return valve 47. The flushing agent inlet 1.2 is likewise connected to the flushing agent control valve 51. The control valve 13 (unlike in FIG. 3) now controls via the flushing agent control valve 51 whether the conveying chamber inlet 1.13 or the flushing inlet 1.2 is supplied with flushing agent 30.

### Conveying Mode

In order to bring the application system into the conveying mode, the system operator turns the rotary knob 71 (see FIG. 6) on the control panel 70 until the rotary knob 71 points at the pictogram 72 with the spray gun. The cam shaft 61 connected to the rotary knob 71 is then in position 0. The application system is now in the conveying mode. The coating material 31 is sprayed as soon as the system operator actuates the trigger lever on the spray applicator 45.

When the rotary knob 71 points at the pictogram 72, this has the effect that the cam shaft 61 of the cam control 60 brings the valves 13, 14, 15 and 16 into the blocked state. No compressed gas thus gets into the control line 36 and the compressed gas lines 37 and 38. Due to the fact that the control line 36 is depressurized, the shut-off device (squeeze valve) 1.5 is open, so that coating material 31 can get via the coating material supply line 9 to the valve inlet 7.1. When the piston 1.4 now moves upwards, coating material 31 is sucked out of the storage container 22 and is sucked into the first conveying chamber 1.11 via the supply line 9, the inlet 1.1, the valve inlet 7.1 and through the inlet valve 7. The non-return valve 1.14 is closed thereby, i.e., blocks.

The coating material, which is already present in the second conveying chamber 1.12, is pushed out of the second conveying chamber 1.12 by means of the piston 1.4 and is transported to the spray applicator 45 via the material line 42, the filter 44 and the material line 43. As soon as the piston 1.4 has reached its upper dead point, the inlet valve 7 closes, so that the first conveying chamber 1.11 is closed on the inlet side. When the piston 1.4 subsequently moves downwards, the coating material 31 is pushed out of the first conveying chamber 1.11 through the non-return valve 1.14 into the second conveying chamber 1.12. The piston 1.4 then moves upwards again and the above-described procedure repeats itself.

In the case of the conveying device, different pressures, such as pump pressure, spraying pressure, circulation pressure, filling pressure and/or cleaning pressure can be set or regulated, respectively.

The pump pressure is the pressure, with which the coating material 32 is present at the conveyor outlet 1.3. It can be set in the conveying mode. The spraying pressure is the pressure, with which the coating material 31 is sprayed onto the workpiece. The circulation pressure is the pressure, with which the material 31 is circulated in the conveying device via a drain valve. The circulation pressure is generally lower than the spraying pressure. The filling pressure is the pressure, with which the material conveyor 1 is filled with coating material 31.

The filling pressure is generally lower than the spraying pressure. The cleaning pressure is the pressure of the flushing medium, with which the material conveyor 1 is to be cleaned (prior to the change into the cleaning mode).

The cleaning pressure is usually lower than the spraying pressure.

### Cleaning Mode

### Position 1: Empty Supply Line 9 (Intake Hose)

In order to bring the application system from the conveying mode into the cleaning mode, the system operator turns the rotary knob 71 on the control panel 70 to the cleaning position (position 1). In this position, the compressed gas valve 14 is actuated by means of the cam 61.3 of the cam shaft 61 and is brought into the open state. This has the effect that compressed gas flows into the flushing line 34 via the compressed gas valve 14, the flow reducer 17, the flushing line 37 and the non-return valve 23. Due to the flow reducer 17, the compressed gas has a throttled volume flow \dot{V}1 into the flushing line 34.

From there, it gets into the flushing line 35 and to the valve inlet 7.7 via the non-return valve 8. The closing force of the return spring 7.8 on the inlet valve 7 is preferably so large that the inlet valve 7 is closed even if the gas pressure is applied. Due to the fact that the squeeze valve 1.5 is open, the coating material in the supply line 9 is transported back with the help of the compressed gas and ultimately gets into a remnant container 21. The valve inlet 7.1, the squeeze valve 1.5, the conveyor inlet 1.1 and the supply line 9 are emptied in this way.

### Position 2: Empty Material Conveyor 1 in the Direction of the Spray Gun

When the system operator brings the rotary knob 71 to position 2, the control valve 13 is opened by means of the cam 61.2, so that compressed air gets to the control connection 1.6 and the shut-off device 1.5 closes the channel 1.9. The compressed gas valve 15 is additionally actuated by means of the cam 61.4 and is brought into the open state. Compressed gas thus gets from the compressed gas source 10 into the flushing line 34 via the compressed gas valve 15 and the compressed gas line 37 with the second compressed gas volume flow \dot{V}2. When the system operator now actuates the trigger on the spray applicator, the inlet valve 7 opens because the pressure in the compressed gas is greater than the return force of the return spring 7.8 in the inlet valve 7.7. The flushing gas thus gets into the first conveying chamber 1.11. From there, the flushing gas flows via the non-return valve 1.14 into the second conveying chamber 1.12 and subsequently into the material hoses 42 and 43 all the way to the spray applicator 45. The remaining coating material is thus sprayed out via the spray applicator 45.

Instead, the drain valve 46 can also be opened on the spray applicator 45, so that the remaining coating material can be drained into the remnant container 21 or back into the storage container 22 via a line 49. The drain valve 46 is closed again when the flushing procedure is completed.

Instead, the drain valve 41 can also be opened on the filter 44, so that the remaining coating material can be drained into the remnant container 21 or back into the storage container 22 via a line. The drain valve 41 is closed again when the flushing procedure is completed.

### Position 3: Flush Supply Line 9 (Intake Hose)

When the system operator turns the rotary knob 71 to position 3, the valves 14 and 16 are actuated by means of the cams 61.1 and 61.8 at the cam shaft 61 and are brought into the open state. Compressed gas thus gets from the compressed gas source 10 into the flushing line 34 via the compressed gas valve 14, the flow reducer 17 and the compressed gas line 37 with the first compressed gas volume flow \dot{V}1. The flushing agent pump 3 is additionally driven with the help of the compressed gas, which gets to the flushing agent pump 3 via the flow valve 16 and the line 38. Said flushing agent pump now conveys flushing agent 30 via the flushing agent line 32 out of the flushing agent container 20 into the flushing agent lines 33 and 34, and from there via the non-return valve 8 into the flushing agent line 35. The flushing agent subsequently gets to the valve inlet 7.1 via the flushing inlet 1.2.

The closing force of the return spring 7.8 at the inlet valve 7 is preferably so large that the inlet valve 7 is closed even if the flushing agent pressure is applied. Due to the fact that the squeeze valve 1.5 is open, the supply line 9 is flushed with the help of the compressed gas and the flushing agent and ultimately gets into a remnant container 21. The valve inlet 7.1, the squeeze valve 1.5, the conveyor inlet 1.1 and the supply line 9 are flushed in this way.

### Position 4: Flush Material Conveyor 1 in the Direction of the Spray Gun 45

When the system operator turns the rotary knob 71 to position 4, the valves 13, 15 and 16 are actuated by means of the cams 61.6 and 61.7 of the cam shaft 61 and are brought into the open state. This has the effect that compressed gas gets to the control input 1.6 of the squeeze valve 1.5 via the control valve 13 and the line 36 and closes the squeeze valve 1.5. Compressed gas furthermore gets from the compressed gas source 10 into the flushing line 34 via the compressed gas valve 15 and the compressed gas line 37 with the volume flow \dot{V}2. The flushing agent pump 3 is additionally driven with the help of the compressed gas, which gets to the flushing agent pump 3 via the flow valve 16 and the line 38. Said flushing agent pump now conveys flushing agent 30 via the flushing agent line 32 out of the flushing agent container 20 into the flushing agent lines 33 and 34, and from there via the non-return valve 8 into the flushing agent line 35. The flushing agent subsequently gets to the valve inlet 7.1 via the flushing inlet 1.2. When the system operator now actuates the trigger on the spray applicator 45, the inlet valve 7 opens because the pressure in the compressed gas (flushing gas) and flushing agent is greater than the return force of the return spring 7.8 in the inlet valve 7.7. The mixture of flushing gas and flushing agent (flushing medium) thus gets into the first conveying chamber 1.11. From there, the mixture flows via the non-return valve 1.14 into the second conveying chamber 1.12 and subsequently into the material hoses 42 and 43 all the way to the spray applicator 43. The flushing medium is thus sprayed out via the spray applicator 45.

Instead, the drain valve 46 can also be opened on the spray applicator 45, so that the flushing medium can be drained via the line 49 into the remnant container 21 or back into the storage container 22. When the flushing procedure is completed, the drain valve 46 is closed again. Instead, the drain valve 41 can also be opened on the filter 44, so that the flushing gas and flushing agent can be drained via a line into the remnant container 21 or back into the storage container 22. The drain valve 41 is closed again when the flushing procedure is completed.

### Position 5: Dry Supply Line 9

In position 5, the compressed gas valve 14 is actuated by means of a cam of the cam shaft 61 (the cam cannot be seen in FIG. 5) and is brought into the open state. This has the effect that compressed gas flows into the flushing line 34 with the first volume flow \dot{V}1. From there, it gets into the flushing line 35 and to the valve inlet 7.7 via the non-return valve 8. Due to the fact that the squeeze valve 1.5 is open, the remaining flushing agent is now blown out via the supply line 9 with the help of the compressed gas. The valve inlet 7.1, the squeeze valve 1.5, the inlet 1.1 and the line 9 can be dried in this way.

### Position 6: Dry Material Conveyor 1 in the Direction of the Spray Gun 45

When the system operator brings the rotary knob 71 to position 6, the control valve 13 and the compressed gas valve 15 are actuated by means of two cams of the cam shaft 61 (cam 61.5 and a second cam, which cannot be seen in FIG. 5) and are brought into the open state. This has the effect that compressed gas gets to the control input 1.6 of the squeeze valve 1.5 via the control valve 13 and the line 36 and closes the squeeze valve 1.5. Compressed gas thus gets from the compressed gas source 10 into the flushing line 34 via the compressed gas valve 15 and the compressed gas line 37 with the second volume flow \dot{V}2. When the system operator now actuates the trigger on the spray applicator 45, the inlet valve 7 opens because the pressure in the compressed gas is greater than the return force of the return spring 7.8 in the inlet valve 7.7. The flushing gas thus gets into the first conveying chamber 1.11. From there, the flushing gas flows via the non-return valve 1.14 into the second conveying chamber 1.12 and subsequently into the material hoses 42 and 43 all the way to the spray applicator 45. The remaining flushing agent, which is still present there, is thus sprayed out via the spray applicator 45.

Instead, the drain valve 46 can also be opened on the spray applicator 45, so that the remaining flushing agent can be blown out via the line 49. The pressure stage 1.8 and the lines 42, 43 or components, respectively, located on the downstream side of the pressure stage can be dried in this way. The drain valve 46 is closed again when the drying procedure is completed.

The flushing or drying, respectively, can take place in a pulsed or continuous manner. The solvent remnants in the material conveyor 1 are blown out with the help of compressed air as flushing medium.

At position 4 (flush material conveyor 1 in the direction of the spray gun 45), it can also be expedient that flushing takes place without compressed air, thus only with flushing agent 30. After completion of the flushing procedure, the material conveyor 1 can be turned off and can be left standing, completely or partly filled with flushing agent 30. When coating material 31 is still present in the material conveyor 1, the flushing agent 30 can now slowly dissolve the material remnants. It is thus ensured that material remnants, which may still be present, do not dry up in the material conveyor 1. An additional switching valve (not shown), which deactivates the compressed gas valve 15, can be installed for this purpose.

In a further embodiment, a throttle 26 (see FIG. 4) is installed in the flushing agent line 33 between the flushing agent pump 3 and the non-return valve 24. The throttle 26 is optional. The flushing agent flow can also be throttled thereby, so that not too much flushing agent 30 flows into the flushing line 34. The supply of the flushing gas into the flushing line 34 can be set better therewith via the flow reducer 19, which is formed, for example, as pressure regulating valve. The flushing agent can be dispersed into fine droplets in the flushing line by means of the throttle 26, whereby a better mixing of flushing gas and flushing agent can be attained.

In the case of one embodiment of the cleaning method, the first conveying chamber 1.11 and preferably also the second conveying chamber 1.12 are emptied prior to the flushing. This can take place, for example, in that the drain valve 41 is opened and the piston 1.4 is moved up and down several times. The coating material, which is still present in the two conveying chambers 1.11 and 1.12, is drained to a large extent thereby via the drain valve 41.

In the case of a further embodiment of the cleaning method, the first conveying chamber 1.11 and preferably also the second conveying chamber 1.12 are dried after the flushing. The drain valve 41 is opened for this purpose and compressed gas is blown through the conveying chambers 1.11 and 1.12.

It can happen that in the case of the coating material conveyor 1 only the two conveying chambers 1.11 and 1.12 (compressor stage 1.8) are to be flushed. The shut-off device 1.5 is activated in this case, so that the conveyor inlet 1.1 is closed. The flushing agent introduced via the flushing inlet 1.2 opens the inlet valve 7 due to the pressure, so that the flushing agent is now directed into the color stage.

In order to flush the intake tract 1.7, the shut-off device 1.5 is opened. The flushing agent introduced via the flushing inlet 1.2 now flows through the intake tract 1.7 in the direction of the supply line 9.

When it is closed, the shut-off device 1.5 makes it possible to build up the flushing agent pressure required for cleaning the compressor stage 1.8, in that it prevents an escape of the flushing agent through the supply line 9.

When it is open, the shut-off device 1.5 makes it possible to guide the flushing agent in the direction of the supply line 9, in order to clean the latter.

The coating material, which is still present in the application system, can be recovered, in that the coating material is displaced from the system by means of compressed gas.

The cleaning method can additionally comprise the following process steps.

The supply line 9 is removed from the material storage container 22 and is guided into the remnant container 21. It is ensured therewith that no flushing agent gets into the material storage container 22 during the flushing of the intake tract 1.7 and of the supply line 9.

The material conveyor 1 can also be run empty, in that the spray applicator 45 is actuated and the piston 1.4 is moved up and down. The remaining coating material is conveyed out via the conveyor outlet 1.3 and is sprayed via the spray applicator 45.

The supply line 9 and/or the piston pump and/or the material hose 42, 43 can advantageously also be blown out with compressed gas. Non-used material can be recovered thereby.

The coating material conveyor 1 and the upstream components (supply line 9, etc.) can be flushed with a gas-solvent mixture. The solvent consumption can be reduced by means of the addition of gas.

The cleaning times can be shortened significantly by means of the above-described method for cleaning the application system.

A disassembly of system components (filter 44, housing 1.15, 1.16, 1.17 at the inlet tract) is not necessary in the case of the above-described method. The manual cleaning effort is also massively reduced thereby.

In some applications, it can be advantageous when the material conveyor 1 remains filled with flushing agent 30 until the next use (conveying of coating material).

After the material conveyor 1 and the respective lines no longer contain any flushing agent 30 and have optionally also been dried, the material conveyor 1 can be filled with coating material 31 again. Some piston strokes are carried out for this purpose in order to convey the coating material 31 into the conveying chambers 1.11 and 1.12. The material conveyor 1 is subsequently ready again to convey coating material 31 to the applicator 45.

The preceding description of the exemplary embodiments according to the present invention only serves illustrative purposes. It goes without saying that changes and modifications are possible. For example, the different components of the application system shown in FIGS. 1 to 6 can also be combined with one another in a different way than shown in the figures.

### LIST OF REFERENCE NUMERALS

1 material conveyor
1.1 inlet for coating material
1.2 inlet for flushing agent/flushing medium
1.3 conveyor outlet
1.4 piston
1.5 shut-off device, for example squeeze valve
1.6 control connection for squeeze valve
1.7 intake tract
1.8 compressor stage/color stage
1.9 channel
1.11 first conveying chamber
1.12 second conveying chamber
1.13 conveying chamber inlet
1.14 non-return valve
1.15 housing on the inlet tract
1.16 housing on the inlet tract
1.17 housing on the inlet tract
1.18 housing of the conveying chamber
2 control
3 conveyor for flushing agent
7 inlet valve
7.1 valve inlet
7.2 valve seat
7.7 valve disk
7.8 spring
7.9 valve outlet
8 valve
8.1 inlet
8.7 valve disk
8.8 spring
8.9 valve outlet
9 supply line
10 compressed air source
11 shut-off valve
12 compressed gas valve
13 control valve
14 compressed gas valve
15 compressed gas valve
16 flow valve
17 flow reducer
18 flow reducer
19 flow reducer
20 container for flushing agent
21 waste container
22 container for coating material
23 non-return valve
24 non-return valve
25 flow reducer
26 throttle
30 flushing agent
31 coating material
32 flushing line
33 flushing line
34 flushing line
35 flushing line
36 control line
37 compressed gas line
38 compressed gas line
39 compressed gas line
39.1 control line
39.2 control line
40 compressed gas line
41 drain valve
42 material line
43 material line
44 filter
45 spray applicator
46 drain valve
47 further shut-off device/non-return valve
48 flushing line
49 flushing line
51 flushing line control valve
60 cam control
61 cam shaft
61.1 cam
61.2 cam
61.3 cam
61.4 cam
61.5 cam
61.6 cam
61.7 cam
61.8 cam
70 control panel
71 rotary knob
72 pictogram

1. A conveying device with flushing means,
with a material conveyor for conveying coating material,
which has an inlet valve, which comprises a valve inlet and a valve outlet, and
which has a conveyor inlet for coating material, which is connected or can be connected to the valve inlet, and
with a flushing agent conveyor for conveying flushing agent, which is likewise connected to the valve inlet.

2. The conveying device according to claim 1, in the case of which the inlet valve is formed as non-return valve.

3. The conveying device according to claim 1, in the case of which the inlet valve is formed as disk valve, ball valve or needle valve.

4. The conveying device according to claim 1, in the case of which the material conveyor is formed as bellows pump, membrane pump, centrifugal pump, gear pump, peristaltic pump, piston pump, piston dosing system or positive displacement pump.

5. The conveying device according to claim 1, in the case of which the flushing agent conveyor is connected to the valve inlet via a non-return valve (8).

6. The conveying device according to claim 1, with a shut-off device, which is arranged between the conveyor inlet and the inlet valve.

7. The conveying device according to claim 6, with a control, which is formed and can be operated in such a way that it controls the shut-off device.

8. The conveying device according to claim 1, with a compressed gas source, which can be connected to the valve inlet.

9. The conveying device according to claim 8, with a compressed gas valve, via which compressed gas originating from the compressed gas source can be admixed to the flushing agent.

10. The conveying device according to claim 8,
in the case of which the flushing agent conveyor is connected to the inlet valve via a flushing line, and - in the case of which the compressed gas source is connected to the flushing line via a non-return valve.

11. The conveying device according to claim 1, with a further shut-off device, which is connected to a conveying chamber inlet of the conveying chamber on the output side and which is connected to the flushing agent conveyor on the input side.

12. The conveying device according to claim 11, with a flushing agent control valve, which is formed and can be operated in such a way that it controls whether the flushing agent flows to the valve inlet or to the conveying chamber inlet.

13. The conveying device according to claim 1,
with a first compressed gas valve, which is connected to the flushing agent line on the output side and which guides a first compressed gas volume flow into the flushing agent line in the open state, and
with a second compressed gas valve, which is connected to the flushing agent line on the output side and which guides a second compressed gas volume flow into the flushing agent line in the open state.

14. The conveying device according to claim 13, with a cam control, via which the compressed gas valves can be controlled.

15. The conveying device according to claim 1, with a squeeze valve, which is formed and can be operated in such a way that it opens or closes the conveyor inlet.

16. An application system, which comprises a conveying device according to claim 1 and an applicator, which is connected to the conveying device.

17. A method for operating a conveying device according to claim 1,
in the case of which the downstream side of the conveying device is closed for flushing the conveyor inlet, and
in the case of which flushing agent is conveyed into the supply line with the help of the flushing agent conveyor.

18. The method according to claim 17, in the case of which flushing agent is conveyed into the first conveying chamber with the help of the flushing agent conveyor for flushing the first conveying chamber.

19. The method according to claim 17, in the case of which the shut-off device is closed and the inlet valve is opened for flushing the first conveying chamber.

20. The method according to claim 17, in the case of which the flushing takes place in a pulsed manner.

21. The method according to claim 17,
in the case of which compressed gas is guided to the conveyor inlet with a first compressed gas volume flow with the help of the first compressed gas valve, when the compressed gas valve is open, and
in the case of which compressed is guided into the conveyor chamber with a second compressed gas volume flow with the help of the second compressed gas valve, when the second compressed gas valve is open.
